(19) United States
(12) Patent Application Publication
(10) Pub. No.: US 2005/0068441 A1
(43) Pub. Date: Mar. 31, 2005

(54) Multiple output CCD for color imaging

(75) Inventor: Christopher Parks, Rochester, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/672,419

(22) Filed: Sep. 26, 2003

(51) Int. Cl. H04N 3/14; H04N 5/335

(52) U.S. Cl. 348/311

(57) ABSTRACT

An image sensor includes a two-dimensional array of photo sensitive pixels for collecting photo generated electron or hole charge packets; (b) a Bayer color filter arranged over the photo sensitive pixels in which the first color is over two pixels and the second and third are over one pixel each in a two by two sub-array of the Bayer color filter; (c) a parallel charge coupled device for transferring charge packets in parallel towards a serial charge coupled device that receives charge packets from the parallel column charge-coupled devices; and (d) a row of pixels between the photo sensitive pixels and the serial charge-coupled device for the purpose of delaying charge transfer of selected rows to offset one column of the Bayer filter pattern such that pixels of the first color become aligned in one row and pixels of the second and third colors become aligned in the following row.

### FIELD OF THE INVENTION

The invention relates generally to the field of image sensors having a Bayer filter in which the colors are clocked to one of two horizontal CCDs and, more particularly, to only clocking the green colors of the Bayer pattern to one horizontal CCD and the blue and red colors of the Bayer pattern to the other horizontal CCD.

### BACKGROUND OF THE INVENTION

The most common method to read out the pixels of a charge-coupled device (CCD) image sensor is to transfer the charge packets in parallel through a vertical CCD towards a horizontal CCD. The horizontal CCD receives one entire row of charge packets from the vertical CCD and the horizontal CCD then transfers the row in serial fashion towards one output amplifier. The drawback of this method is that the read out time of the image sensor is limited by the clock frequency of the horizontal CCD. The only way to decrease the read out time is to increase the clock frequency. Increasing the clock frequency leads to higher output noise and more complex electronic circuitry.

A method employed to decrease the readout time is to add multiple horizontal CCDs. Two examples of many variations of multiple horizontal CCDs are given in U.S. Pat. Nos. 4,949,183 and 5,040,071. The drawback of this output structure is the output amplifiers at the end of each horizontal CCD will not have exactly the same voltage output for the same size charge packets. The camera signal processing electronics for each output will also not be perfectly matched. This difference in pixel values between the two outputs produces a noticeable visual artifact in the image.

U.S. Pat. No. 5,040,071 attempts to address the issue of output amplifier differences by re-arranging the CFA pattern as shown in FIG. 1. The color filter array (CFA) pattern is changed to a GBGR (green 1, blue 2, green 1, red 4) repeating pattern on every row. The horizontal CCD output structure places all of the red 4 and blue pixels 2 into one particular horizontal CCD 10 and all of the green pixels 1 into the other horizontal CCD 20. The benefit of this arrangement is that any differences in the output amplifiers will show in the image as a slight color error. All of the green pixels 1 are read out of one output. The output amplifier differences will be in the color domain instead of the luminance domain. It is well known that the human eye is more sensitive to luminance errors than color errors.

The drawback of U.S. Pat. No. 5,040,071 is that the pixel array does not employ the Bayer CFA pattern. The Bayer color filter pattern provides a more pleasing visual image than the striped GBGR CFA pattern.

Consequently, a need exists for addressing this drawback by having a Bayer filter pattern where output amplifier imbalances are in the color domain.

### SUMMARY OF THE INVENTION

The present invention is directed to overcoming one or more of the problems set forth above. Briefly summarized, according to one aspect of the present invention, the invention resides in an image sensor comprising (a) a two-dimensional array of photo sensitive pixels for collecting photo generated electron or hole charge packets; (b) a Bayer color filter arranged over the photo sensitive pixels in which the first color is over two pixels and the second and third are over one pixel each in a two by two sub-array of the Bayer color filter; (c) a parallel charge-coupled device for transferring charge packets in parallel towards a serial charge-coupled device that receives charge packets from the parallel column charge-coupled devices; and (d) a row of pixels between the photo sensitive pixels and the serial charge-coupled device for the purpose of delaying charge transfer of selected rows to offset one column of the Bayer filter pattern such that pixels of the first color become aligned in one row and pixels of the second and third colors become aligned in the following row.

These and other aspects, objects, features and advantages of the present invention will be more clearly understood and appreciated from a review of the following detailed description of the preferred embodiments and appended claims, and by reference to the accompanying drawings.

Advantageous Effect Of The Invention

The present invention has the advantage of providing one particular color sampled by the same output.

### BRIEF DESCRIPTION OF THE DRAWINGS

FIG. 1 is a top view of a prior art image sensor;

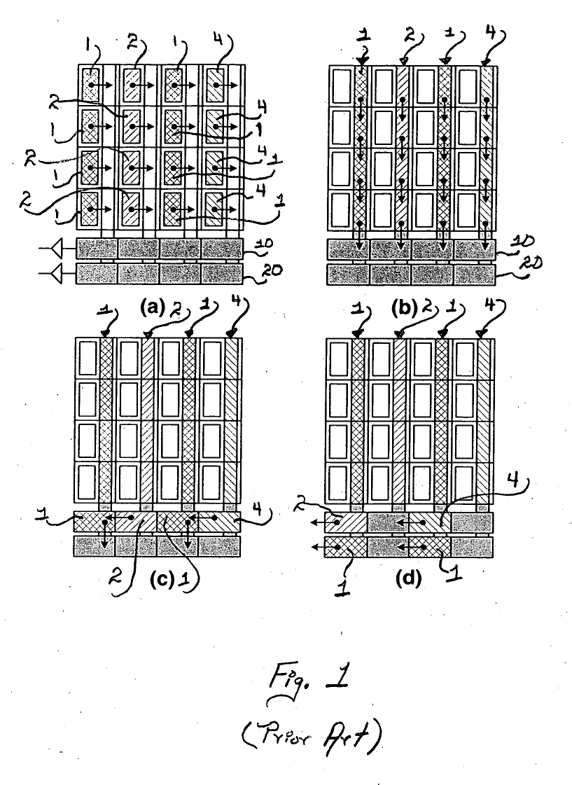

FIG. 2 is a top view of an image sensor of the present invention illustrating transfer of charge through the sensor and output structure;

FIG. 3 is a detail view of a delay CCD of FIG. 2;

FIG. 4 is an alternative embodiment of FIG. 3;

FIG. 5 is an alternative embodiment of FIG. 2; and

FIG. 6 is a digital camera for implementing a commercial embodiment of the image sensor of the present invention.

### DETAILED DESCRIPTION OF THE INVENTION

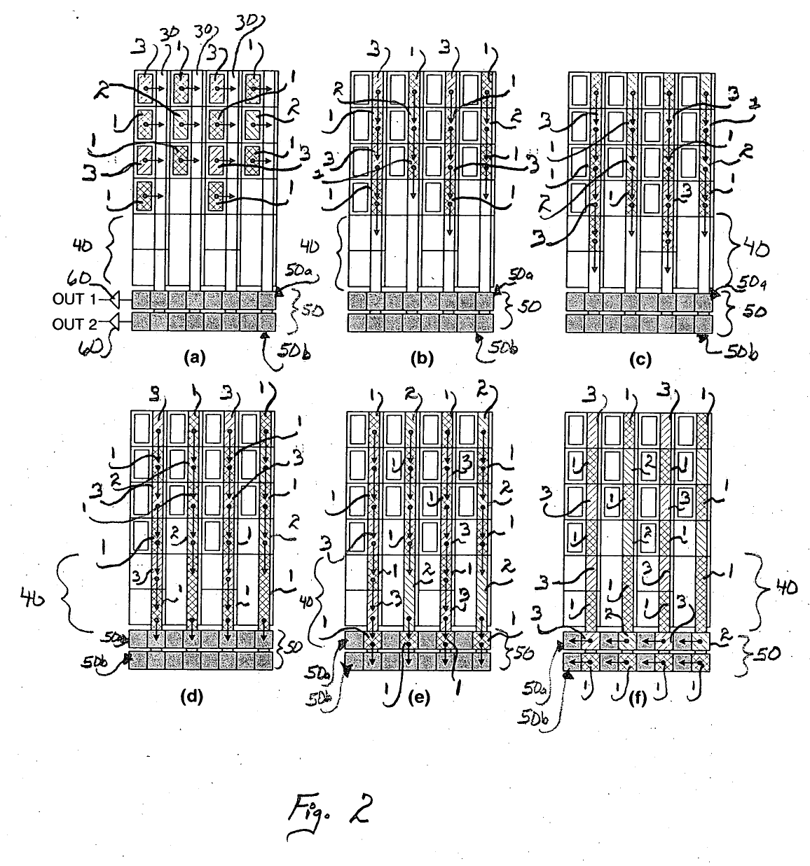

Referring to FIG. 2, the preferred embodiment of the invention consists of a two-dimensional array of pixels with the Bayer color filter array (CFA) pattern (red 3, green 1 and blue 2). Each pixel is of the type with a photo-sensing site (under each color of FIG. 2a and not numbered) next to a charge-coupled device (CCD) channel (numbered 30 in FIG. 2a). It is noted that the photo-sensing site may be omitted if the CCD channel itself is to be used as the photo-sensing site. At the bottom of the pixel array, a unique row of pixels 40, hereinafter referred to as charge delay row, is positioned between the serial (horizontal) CCDs 50 and the pixel array for delaying the charge transfer of selected columns. Or conversely, it is equivalent to say that this row 40 advances charge packets of selected columns ahead of charge packets in other columns. The charge delay row 40 generally has no photo-sensitive site, but this is not required.

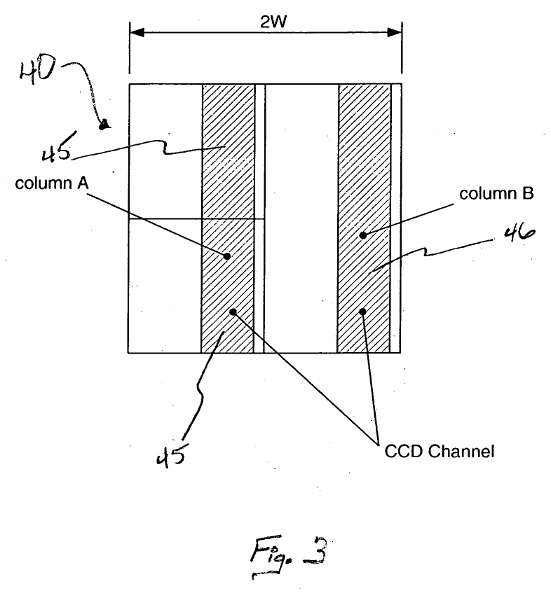

Referring to FIG. 3, a detailed view of each unit cell of the charge delay row 40 is illustrated. The unit cell is preferably the width of two pixels. The length is of no unique value. Column A is constructed such that it requires two complete clocking cycles of the vertical CCD control gates 45 for the charge packets to pass through the unit cell. Column B is constructed such that it requires one clock cycle of the vertical CCD control gates 46 for the charge packets to pass through the unit cell. The unit cell is repeated across a row for the entire width of the photo-active pixel array. The purpose of this charge delay row 40 is to delay one column of the Bayer CFA pattern by one row so the green pixels become aligned when transferred into the horizontal CCD 50, as will be illustrated later herein.

Referring to FIG. 2, the transferring sequence begins in FIG. 2a after the image collected in the photo-sensitive sites is transferred to the vertical CCD 30. Alternatively, the image may be collected directly in the vertical CCD. Next, the image is shifted towards the horizontal CCD 50 and into the charge delay row 40 as shown in FIGS. 2b through 2d. Note that in FIG. 2d the green pixels 1 are now aligned along a row. As is apparent from the drawing, this is because the green colors 1 closer to the delay row includes only one transfer through the delay row 40, and the green colors 1 farther from the delay row 40 (in the next row up) are transferred once in the delay row. Upon the next vertical CCD 30 transfer cycle only green pixels 1 are transferred into the first horizontal CCD 50a. If only one output is to be used, the first horizontal CCD 50a transfers the entire row to the output amplifier. If two outputs are to be used for faster readout, the signal from the first horizontal CCD 50a is transferred in to the adjacent second horizontal CCD 50b as shown in FIG. 2e. The vertical CCD 30 also shifts the next row of the pixel array into the first horizontal CCD 50a. At this point in FIG. 2f, the first horizontal CCD 50a contains only red 3 and blue pixels 1 and the second horizontal CCD 50b contains only green pixels 1. Both horizontal CCDs 50 now transfer their contents in a serial fashion to the output amplifiers 60 (only illustrated in FIG. 2a). In this embodiment of the invention, the Bayer color filter pattern is re-arranged by the charge delay row 40 so that all green pixels 1 are placed in one horizontal CCD 50. In comparison, the prior art often transfers the green pixels into two different horizontal CCDs.

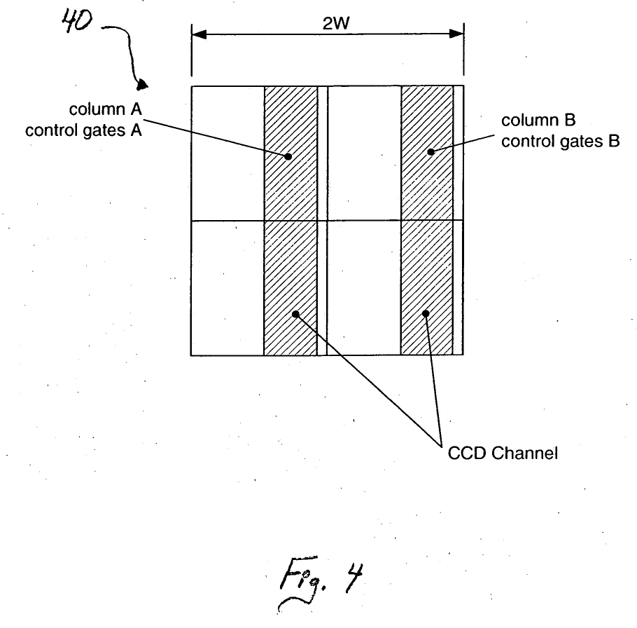

In the second embodiment of the invention, the charge delay row unit cell may be constructed as shown in FIG. 4. Referring to FIG. 4, in the charge delay row 40, the gates that control charge transfer in column A are independent of gates which control charge transfer in column B. The unit cell is two pixels wide. The unit cell is also two pixels (two rows) in length. In this embodiment, when a row of charge packets enters the charge delay row 40, the control gates B in column B are actuated through one extra clock cycle to advance the charge packet forward one extra row relative to charge packets in column A. This achieves the same effect as the preferred embodiment of FIG. 3 but it does so with extra clocking drivers.

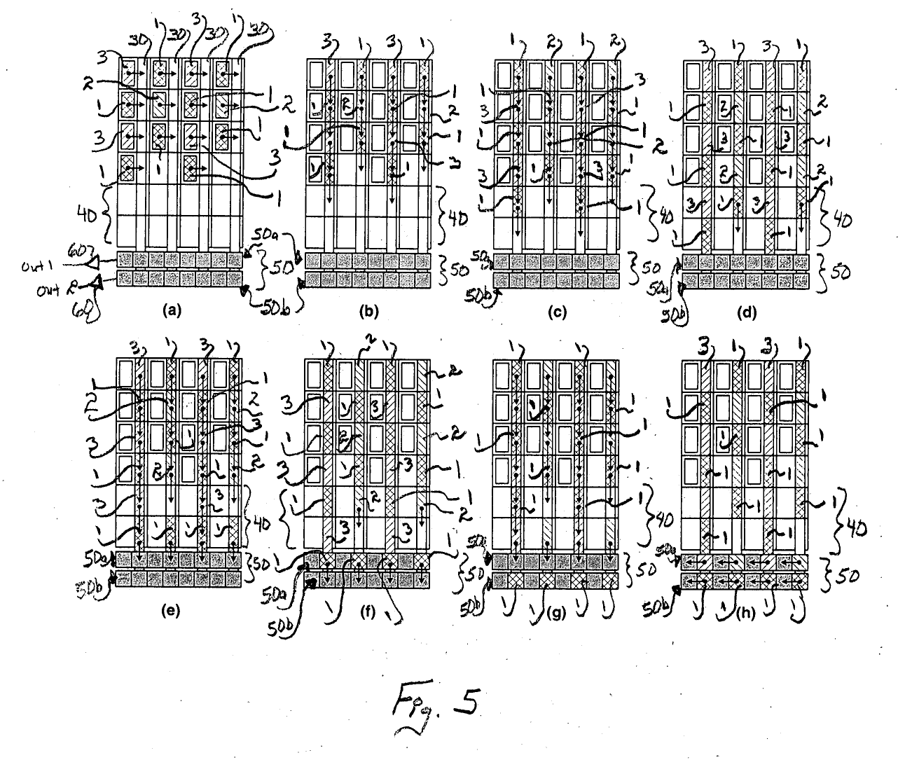

FIG. 5 illustrates the charge transfer sequence of the second embodiment. It begins in FIG. 5a where the image charge collected in the photo-sites of the pixels is transferred to the vertical CCD 30 (only shown in FIG. 5a for simplicity) of the pixels. The charge packets are then transferred through the vertical CCD 30 and into the charge delay row 40 in FIGS. 5b and 5c. In FIG. 5d, only the vertical CCD control gates of column B of the charge delay row unit cell are actuated to move a charge packet ahead one row relative to column A. This places all of the green pixels 1 in the same row ready to be transferred into the horizontal CCD 50a as in FIG. 5e. In FIG. 5f, the vertical CCD control gates of column B are again actuated independent of those in column A. This places the red 3 and blue 2 charge packets all in the same row ready to be transferred in to the horizontal CCD 50a. The green row 1 in the first horizontal CCD 50a is transferred into the second horizontal CCD 50b. Next in FIG. 5g, the red/blue 3 and 2 row is transferred into the first horizontal CCD 50a. Finally in FIG. 5h, the two horizontal CCDs 50 transfer their charge packets to the output amplifiers 60 (only shown in FIG. 5a).

It should be recognized that minor variations of the second embodiment clocking are possible. Such as clocking the delay row column A gates the same as the main pixel array vertical CCD gates, and using separate clocks for column B gates. Conversely, clocking the delay row column B gates the same as the main pixel array vertical CCD gates, and using separate clocks for column A gates It is also an obvious variation that if the column A gates are clocked the same as the main pixel array only a portion of the column B gates of the delay row need be clocked differently than the main pixel array gates. The column A gates and column B gates may also be clocked together in unison with the main pixel array to read out the color filter pattern in a manner equivalent to the prior art.

It is also noted as obvious that the gate structure of the vertical CCD and the charge delay row may be of the well known CCD types of 1-phase, 2-phase, 3-phase, 4 or more phase CCD architectures. It is also noted that the charge delay rows may be combined with a charge-clearing structure as described in U.S. Pat. No. 5,440,343 or other such vertical to horizontal CCD charge blocking structure.

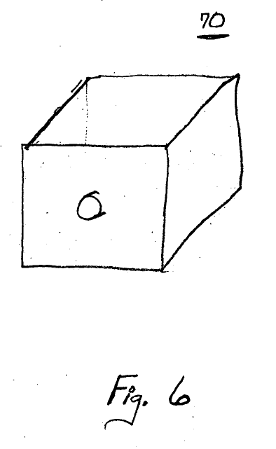

Referring to FIG. 6, there is shown a digital camera 70 for implementing the image sensor and output CCDs into a commercial embodiment to which an ordinary consumer is accustomed.

The invention has been described with reference to a preferred embodiment. However, it will be appreciated that variations and modifications can be effected by a person of ordinary skill in the art without departing from the scope of the invention.

### PARTS LIST

1 green
2 blue
3 red
4 red
10 horizontal CCD
20 horizontal CCD
30 vertical CCD
40 charge delay row
45 vertical CCD control gates
46 vertical CCD control gates
50 horizontal CCD
60 output amplifier
70 digital camera

1. An image sensor comprising:
(a) a two-dimensional array of photo sensitive pixels for collecting photo generated electron or hole charge packets;
(b) a Bayer color filter arranged over the photo sensitive pixels in which the first color is over two pixels and the second and third are over one pixel each in a two by two sub-array of the Bayer color filter;
(c) a parallel charge coupled device for transferring charge packets in parallel towards a serial charge coupled device that receives charge packets from the parallel column charge-coupled devices; and
(d) a row of pixels between the photo sensitive pixels and the serial charge-coupled device for delaying charge transfer of selected rows to offset one column of the Bayer filter pattern such that pixels of the first color become aligned in one row and pixels of the second and third colors become aligned in the following row.

2. The image sensor as defined in claim I further comprising a second serial charge-coupled devices, wherein one serial CCD receives a row of pixels, of the first color and then transfers the row of pixels of the first color to a second adjacent serial CCD, and the first serial CCD then receives another row of pixels of the second and third color so that the first and second serial CCD's then transfer in a serial manner.

3. The image sensor as defined in claim 1 further comprising a second serial charge-coupled device, wherein one serial CCD receives a row of pixels of the second and third color and then transfers the row of pixels of the second and third color to a second adjacent serial CCD, and the first serial CCD then receives another row of pixels of the first color so that the first and second serial CCD's then transfer in a serial manner.

4. The image sensor as in claim 1, wherein the row of pixels between the photo sensitive pixels and the serial charge-coupled device include a sub-array of pixels arranged in two columns such that the first column contains one pixel and the second column contains two pixels.

5. The image sensor as in claim 1, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.

6. The image sensor as in claim 2, wherein the row of pixels between the photo sensitive pixels and the serial charge-coupled device include a sub-array of pixels arranged in two columns such that the first column contains one pixel and the second column contains two pixels.

7. The image sensor as in claim 3, wherein the row of pixels between the photo sensitive pixels and the serial charge-coupled device include a sub-array of pixels arranged in two columns such that the first column contains one pixel and the second column contains two pixels.

8. The image sensor as in claim 2, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.

9. The image sensor as in claim 3, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.

10. A digital camera comprising:
(a) An image sensor comprising:
(a1) a two-dimensional array of photo sensitive pixels for collecting photo generated electron or hole charge packets;
(a2) a Bayer color filter arranged over the photo sensitive pixels in which the first color is over two pixels and the second and third are over one pixel each in a two by two sub-array of the Bayer color filter;
(a3) a parallel charge coupled device for transferring charge packets in parallel towards a serial charge coupled device that receives charge packets from the parallel column charge-coupled devices; and
(a4) a row of pixels between the photo sensitive pixels and the serial charge-coupled device for the purpose of delaying charge transfer of selected rows to offset one column of the Bayer filter pattern such that pixels of the first color become aligned in one row and pixels of the second and third colors become aligned in the following row.

11. The camera as defined in claim 10 further comprising a second serial charge-coupled devices, wherein one serial CCD receives a row of pixels of the first color and then transfers the row of pixels of the first color to a second adjacent serial CCD, and the first serial CCD then receives another row of pixels of the second and third color so that the first and second serial CCDs then transfer in a serial manner.

12. The camera as defined in claim 10 further comprising a second serial charge-coupled device, wherein one serial CCD receives a row of pixels of the second and third color and then transfers the row of pixels of the second and third color to a second adjacent serial CCD, and the first serial CCD then receives another row of pixels of the first color so that the first and second serial CCDs then transfer in a serial manner.

13. The camera as in claim 10, wherein the row of pixels between the photo sensitive pixels and the serial charge-coupled device include a sub-array of pixels arranged in two columns such that the first column contains one pixel and the second column contains two pixels.

14. The camera as in claim 10, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.

15. The camera as in claim 11, wherein the row of pixels between the photo sensitive pixels and the serial charge-coupled device include a sub-array of pixels arranged in two columns such that the first column contains one pixel and the second column contains two pixels.

16. The camera as in claim 12, wherein the row of pixels between the photo sensitive pixels and the serial charge-coupled device include a sub-array of pixels arranged in two columns such that the first column contains one pixel and the second column contains two pixels.

17. The camera as in claim 11, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.

18. The camera as in claim 12, wherein the row of pixels between the photo sensitive pixels and the serial charge-coupled device include a sub-array of pixels arranged in two columns of two pixels each such that the first column transfers charge packets the substantially the same as the two dimensional array and the second column transfers charge packets independent of the two dimensional array.
